(19) United States
(12) Patent Application Publication
(10) Pub. No.: US 2025/0379942 A1
(43) Pub. Date: Dec. 11, 2025

(54) LOW-POWER CONCURRENT VOICE CALL AND VOICE ACTIVATION PROCESSING

(71) Applicant: QUALCOMM Incorporated, San Diego, CA (US)

(72) Inventors: Asif Imroz MOHAMMED, Hyderabad (IN); Anuj DESHMUKH, Nagpur (IN); Venna VENKATESH, Hyderabad (IN)

(21) Appl. No.: 18/734,853

(22) Filed: Jun. 5, 2024

(51) Int. Cl. H04M 19/00; G10L 15/08; G10L 21/0216; G10L 25/78

(52) U.S. Cl. CPC H04M 19/00; G10L 15/08; G10L 21/0216; G10L 25/78; G10L 2015/088

(57) ABSTRACT

A device includes an audio processor. The audio processor is configured to, responsive to transitioning from a low-power state to an active state during a voice call: activate a voice call processing path and a voice activation processing path; process, at the voice call processing path, voice call audio data; and process, at the voice activation processing path, voice activation audio data. The audio processor is also configured to, after processing has completed at both the voice call processing path and the voice activation processing path, transition from the active state to the low-power state.

### I. FIELD

The present disclosure is generally related to voice activation processing during a voice call.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to capture user speech from one or more microphones and encode the user speech for transmission to a remote device during a voice call. In some cases, power consumption associated with the voice call can be reduced by having components associated with the voice call, such as a modem and a processor that encodes the user's speech for transmission, enter a low-power state during periods of the voice call where uplink and downlink communications are not scheduled to occur.

A popular feature of various mobile communication devices allows users to use keyword-driven voice commands to activate one or more function of the devices. Referred to as voice activation, this feature typically includes continuously monitoring microphone inputs to determine if a keyword is detected. Upon detection of a spoken keyword, audio data may be processed using more powerful speech recognition techniques of one or more voice activation applications.

However, because audio processing for voice activation is often performed using some of the same processing components as are used for voice processing during calls, such audio processing can prevent the processing components from being able to enter the low-power state that would otherwise be available during a voice call. As a result, concurrent voice call and voice activation processing can result in higher power consumption during a voice call, which can increase the discharge rate of a battery of a mobile communication device, decrease the usage time of the mobile communication device before having to recharge the battery, and negatively impact a user experience.

### III. SUMMARY

According to a particular aspect, a device includes an audio processor. The audio processor is configured to, responsive to transitioning from a low-power state to an active state during a voice call: activate a voice call processing path and a voice activation processing path; process, at the voice call processing path, voice call audio data; and process, at the voice activation processing path, voice activation audio data. The audio processor is also configured to, after processing has completed at both the voice call processing path and the voice activation processing path, transition from the active state to the low-power state.

According to a particular aspect, a method includes transitioning, at an audio processor, from a low-power state to an active state during a voice call and, responsive to transitioning to the active state: activating a voice call processing path and a voice activation processing path; processing voice call audio data at the voice call processing path; and processing voice activation audio data at the voice activation processing path. The method also includes transitioning, at the audio processor, from the active state to the low-power state after processing has completed at both the voice call processing path and the voice activation processing path.

According to a particular aspect, a non-transitory computer-readable medium stores instructions that, when executed by an audio processor, causes the audio processor to transition from a low-power state to an active state during a voice call and, responsive to transitioning to the active state: activate a voice call processing path and a voice activation processing path; process voice call audio data at the voice call processing path; and process voice activation audio data at the voice activation processing path. The instructions, when executed by the audio processor, also cause the audio processor to, after processing has completed at both the voice call processing path and the voice activation processing path, transition from the active state to the low-power state.

According to a particular aspect, an apparatus includes means for transitioning from a low-power state to an active state during a voice call. The apparatus includes means for activating a voice call processing path and a voice activation processing path responsive to transitioning to the active state. The apparatus includes means for processing voice call audio data at the voice call processing path. The apparatus includes means for processing voice activation audio data at the voice activation processing path. The apparatus also includes means for transitioning from the active state to the low-power state after processing has completed at both the voice call processing path and the voice activation processing path.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a diagram that includes a block diagram and a timing diagram of a particular illustrative aspect of a system operable to perform concurrent voice call and voice activation processing during a voice call, in accordance with some examples of the present disclosure.

FIG. 2 is a diagram of particular aspects of the system of FIG. 1, in accordance with some examples of the present disclosure.

FIG. 3 is a timing diagram illustrating particular aspects of the system of FIG. 1, in accordance with some examples of the present disclosure.

FIG. 4 illustrates an example of an integrated circuit operable to perform concurrent voice call and voice activation processing during a voice call, in accordance with some examples of the present disclosure.

FIG. 5 is a diagram of a mobile device operable to perform concurrent voice call and voice activation processing during a voice call, in accordance with some examples of the present disclosure.

FIG. 6 is a diagram of a headset operable to perform concurrent voice call and voice activation processing during a voice call, in accordance with some examples of the present disclosure.

FIG. 7 is a diagram of a wearable electronic device operable to perform concurrent voice call and voice activation processing during a voice call, in accordance with some examples of the present disclosure.

FIG. 8 is a diagram of a voice-controlled speaker system operable to perform concurrent voice call and voice activation processing during a voice call, in accordance with some examples of the present disclosure.

FIG. 9 is a diagram of a vehicle operable to perform concurrent voice call and voice activation processing during a voice call, in accordance with some examples of the present disclosure.

FIG. 10 is a diagram of a particular implementation of a method of performing concurrent voice call and voice activation processing that may be performed by the device of FIG. 1, in accordance with some examples of the present disclosure.

FIG. 11 is a block diagram of a particular illustrative example of a device that is operable to perform concurrent voice call and voice activation processing, in accordance with some examples of the present disclosure.

### V. DETAILED DESCRIPTION

With the growing popularity of voice activation features, mobile devices are increasingly expected to support voice activation operations of device users during voice calls. However, because audio processing for voice activation is often performed using some of the same processing components as are used for voice processing during calls, such audio processing can prevent the processing components from being able to enter the low-power state that would otherwise be available during a voice call. As a result, supporting voice activation can result in higher power consumption during a voice call, which can increase the discharge rate of a battery of a mobile communication device, decrease the usage time of the mobile communication device before having to recharge the battery, and negatively impact a user experience.

Systems and methods of low-power concurrent voice call and voice activation processing are described. For example, according to a particular aspect, operations associated with voice activation processing during a voice call are temporally aligned with the voice processing operations for the voice call, which enables a communication device (e.g., a mobile phone) to schedule periods during which audio processing components can enter a low-power state, such as a low power island (LPI) mode, based on call timing criteria. Aligning the voice call and voice activation processing operations and entering the low-power state based on the call timing criteria provides the technical advantage of reducing or eliminating the additional power consumption caused by voice activation processing preventing processing components from entering the low-power state in conventional devices. Thus, the usage time of the communication device between battery charges and the user experience are improved.

In accordance with some aspects, the voice call audio data and voice activation audio data are processed at an audio processor, such as a digital signal processor. In some implementations, alignment of processing of the voice activation audio data with processing of the voice call audio data and with a modem sleep/wake cycle is achieved using a synchronizer in the voice call processing path that communicates control signals to a gate of the voice activation processing path. The control signals cause the gate to block processing of voice activation processing data during the sleep cycle of the modem. In some implementations, a central sleep manager tracks the active/idle duration of all threads running on the audio processor and triggers entry into a low power island mode once all of the threads transition to an idle state, allowing the audio processor to enter a power collapse mode.

In accordance with some aspects, additional power savings are obtained by bypassing a noise suppression operation in the voice call processing path, in the voice activation processing path, or both, in response to detecting a silence condition in the incoming audio data of the corresponding processing path. In an example, a module such as an audio silence indicator is set to determine whether the incoming audio data has a sound level (e.g., a noise level or signal level) below a threshold. When the sound level is below the threshold, noise reduction processing of the incoming audio data, such as echo cancellation and noise suppression, is bypassed (e.g., skipped). Selectively bypassing noise reduction processing based on an audio silence indicator provides the technical advantage of reducing processing time and power consumption associated with performing echo cancellation and noise suppression, for audio data that is likely devoid of useful content. In addition to the reduced power consumption due to bypassing noise reduction processing, additional power savings are attained by enabling earlier entry into the power collapse mode when the noise reduction processing is bypassed in cases in which the noise reduction processing is otherwise delaying entry into the power collapse mode.

Thus, according to some aspects, using audio silence indicator modules to determine the environmental conditions and then dynamically enabling or disabling noise suppression processing results provides the technical advantage of reduced voice call processing and voice activation processing times in case of silence. Aligning the voice activation processing with voice call processing during concurrent operation of each helps the voice activation processing to align with a modem awake state and avoid overlap with a modem sleep state, thereby enabling a power collapse for the entire modem sleep state and providing the technical advantage of improving the system's overall performance while reducing its power consumption.

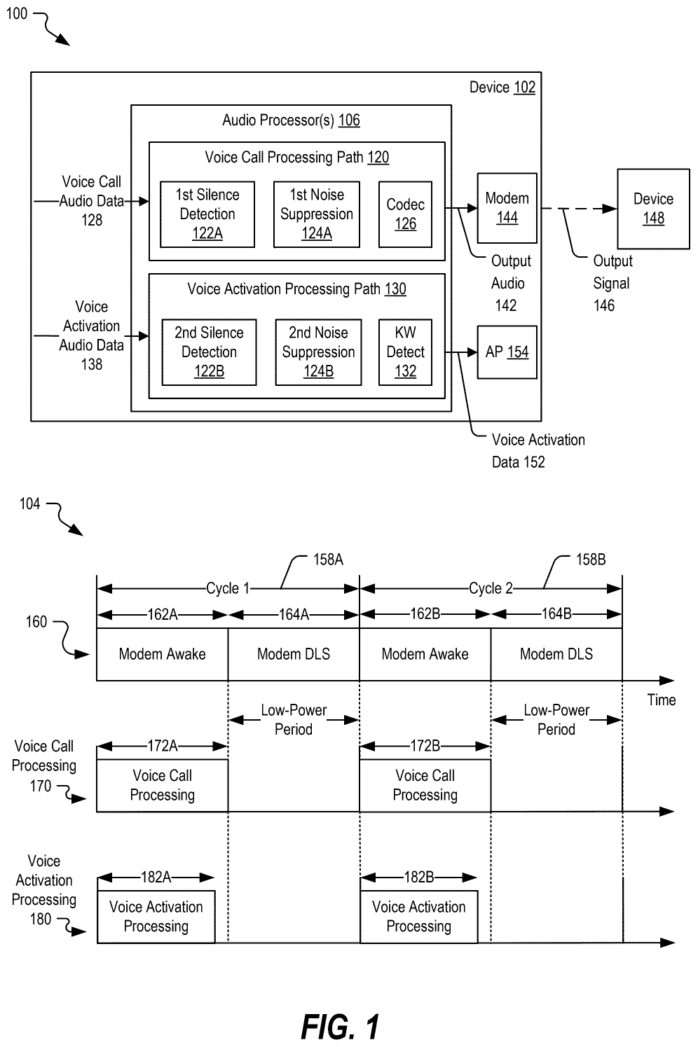

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more audio processors (“audio processor(s)” 106 of FIG. 1), which indicates that in some implementations the device 102 includes a single audio processor 106 and in other implementations the device 102 includes multiple audio processors 106. For ease of reference herein, such features are generally introduced as “one or more” features and are subsequently referred to in the singular or optional plural (as indicated by “(s)” in the name of the feature) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple time periods in which a modem is in an active state are illustrated and associated with reference numbers 162A and 162B. When referring to a particular one of these time periods, such as a time period 162A, the distinguishing letter “A” is used. However, when referring to any arbitrary one of these time periods or to these time periods as a group, the reference number 162 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

Referring to FIG. 1, a particular illustrative aspect of a system 100 and a timing diagram 104 associated with processing voice call audio data and voice activation audio data for concurrent processing during a voice call are shown. In the example illustrated in FIG. 1, the system 100 includes a device 102 configured to process voice call audio data 128 for transmission to, and playout at, another device 148 during the voice call. In an illustrative example, the device 148 corresponds to a mobile phone, a headset device, etc., to enable telephonic communication between a user of the device 102 and the device 148 over one or more wired or wireless communication networks (e.g., long-term evolution (LTE), 5G New Radio (NR), etc.) (LTE is a trademark of European Telecommunications Standards Institute). The device 102 is also configured to process voice activation audio data 138 during the voice call to enable voice activation functionality while the voice call is ongoing.

The device 102 includes one or more audio processors 106 coupled to a modem 144 and an application processor (AP) 154. The audio processor 106 includes a digital signal processor (DSP), one or more other types of processor, or a combination thereof. The audio processor 106 is configured to transition between active and low-power states substantially concurrently with corresponding transitions of the modem 144 that are based on timing criteria associated with the voice call. As a result, power consumption associated with audio processing during the voice call can be reduced.

The audio processor 106 is configured, responsive to transitioning from a low-power state to an active state during the voice call, to activate a voice call processing path 120 and a voice activation processing path 130, process the voice call audio data 128 at the voice call processing path 120, and process the voice activation audio data 138 at the voice activation processing path 130. According to an aspect, the voice call audio data 128 corresponds to one or more frames of audio data that are received for processing at the voice call processing path 120. In an illustrative implementation, the voice call audio data 128 is received from a first audio source, such as via a microphone that is implemented in or coupled to the device 102. The voice call audio data 128 can be processed for transmission to the device 148 as the voice content of the voice call.

According to an aspect, the voice activation audio data 138 corresponds to one or more frames of audio data that are received and processed at the voice activation processing path 130 to enable voice activation functionality during the voice call. According to an aspect, the voice activation audio data 138 corresponds to beamformed audio data that is generated by the device 102 using audio captured by multiple microphones that are integrated in or coupled to the device 102.

In some embodiments, the audio processor 106 is configured to perform a silence detection operation 122 in each of the voice call processing path 120 and the voice activation processing path 130 and to selectively bypass a noise suppression operation 124 in at least one of the voice call processing path 120 or the voice activation processing path 130 based on the silence detection operation 122. To illustrate, the voice call processing path 120 includes a first audio silence detector configured to perform a first audio silence detection operation 122A of the voice call audio data 128 to determine whether the voice call audio data 128 has a sound level (e.g., a noise level or energy, a signal level or energy, or a combination thereof) below a first threshold.

In some embodiments, the voice call processing path 120 also includes a first noise suppressor configured to selectively perform a first noise suppression operation 124A of the voice call audio data 128 based on the first audio silence detection operation 122A. For example, the audio processor 106 selects, based on the first audio silence detection operation 122A, whether or not to perform the first noise suppression operation 124A. To illustrate, when the first audio silence detection operation 122A determines that the sound level of the voice call audio data 128 is below the first threshold, the first noise suppression operation 124A is bypassed. Otherwise, when the sound level of the voice call audio data 128 equals or exceeds the first threshold, the first noise suppression operation 124A (e.g., noise reduction, echo cancellation, or both) is performed on the voice call audio data 128.

The voice call processing path 120 also includes an encoder configured to encode an output of the first noise suppressor. For example, a codec 126 is configured to perform encoding on the voice call audio data 128 after the first noise suppression operation 124A has been performed (or bypassed) to generate output audio 142 at the voice call processing path 120 for transmission during the voice call. After generating the output audio 142, the audio processor 106 is configured to transition from the active state back to the low-power state based on timing criteria associated with the voice call. For example, after processing has completed at both the voice call processing path 120 and the voice activation processing path 130, the audio processor 106 is configured to transition from the active state to the low-power state.

The modem 144 is configured to initiate transmission of an output signal 146 based on the voice call audio data 128. To illustrate, the voice call audio data 128 is selectively processed by the first noise suppression operation 124A and encoded at the codec 126 to generate the output audio 142, and the output audio 142 is processed at the modem 144 to generate the output signal 146. In some implementations, the transmitted of the output signal 146 includes user voice content of the voice call audio data 128. The modem 144 is also configured to transition between a low-power state and an active state based on the timing criteria associated with the voice call.

The voice activation processing path 130 includes a second audio silence detector configured to perform a second audio silence detection operation 122B of the voice activation audio data 138 to determine whether the voice activation audio data 138 has a sound level (e.g., a noise level or energy, a signal level or energy, or a combination thereof) below a second threshold. In some embodiments, the second threshold is greater than the first threshold, less than the first threshold, or matches the first threshold. The voice activation processing path 130 also includes a second noise suppressor configured to selectively perform a second noise suppression operation 124B of the voice activation audio data 138 based on the second audio silence detection operation 122B. For example, the audio processor 106 selects, based on the second audio silence detection operation 122B, whether or not to perform the second noise suppression operation 124B in a similar manner as described for the first noise suppression operation 124A. To illustrate, when the second audio silence detection operation 122B determines that the sound level of the voice activation audio data 138 is below the second threshold, the second noise suppression operation 124B is bypassed. Otherwise, when the sound level of the voice activation audio data 138 equals or exceeds the second threshold, the second noise suppression operation 124B (e.g., noise reduction, echo cancellation, or both) is performed on the voice activation audio data 138.

The voice activation processing path 130 also includes a keyword detector configured to perform a keyword detection operation 132 that processes an output of the second noise suppression operation 124B to determine wither the voice activation audio data 138 includes a keyword. When a keyword is detected, the audio processor 106 sends voice activation data 152 to the application processor 154. According to an aspect, the voice activation data 152 is generated at the voice activation processing path 130 and includes an indication of which keyword was detected (e.g., in embodiments in which multiple keyword detectors are included in the voice activation processing path 130), a pointer to a history buffer location associated with the detected keyword, audio data copied from the history buffer, or a combination thereof. When a keyword is not detected, the voice activation data 152 is not generated, or is generated to provide an indication to the application processor 154 that no keyword was detected.

After processing associated with the voice activation data 152 has completed, or when no keyword is detected, the audio processor 106 is configured to transition from the active state back to the low-power state based on timing criteria associated with the voice call. For example, after processing has completed at both the voice call processing path 120 and the voice activation processing path 130, the audio processor 106 is configured to transition from the active state to the low-power state.

The application processor 154 is configured to process an output of the voice activation processing path 130. The voice activation data 152 is processed by the application processor 154 to recognize and respond to specific voice commands, enabling hands-free control of and interaction with the device 102. In some embodiments, the application processor 154 is also configured to transition from an active state to a low-power state when there are no active threads running at the application processor 154 to further conserve power at the device 102.

The timing diagram 104 illustrates an example of operation of the device 102 in which transitions between an active state and a low-power state of the modem 144 are aligned with the transitions between the active state and the low-power state of the audio processor 106 to enable synchronized processing using a low power island. The timing diagram 104 depicts modem operations 160, voice call processing operations 170, and voice activation processing operations 180 during multiple cycles 158 associated with the voice call, including a first cycle (“cycle 1”) 158A and a second cycle (“cycle 2”) 158B. In each cycle 158, an awake period 162 indicates a time period in which the modem 144 is in an active state, and a low-power period 164 indicates a time period in which the modem 144 is not active and can enter a low-power state (e.g., a Deep/Light Sleep (“DLS”) mode) to conserve power. In a particular implementation, the voice call is a connected mode discontinuous reception (CDRx) call, and timing criteria associated with the cycles 158 (e.g., the length of the awake period 162 and the length of the low-power period 164) are based on a CDRx cycle configuration. In an illustrative, non-limiting example, the duration of each cycle 158 is 40 milliseconds (ms), the duration of the awake period 162 is 20 ms, and the duration of the low-power period 164 is 20 ms. The low-power period 164 having the same duration as the awake period 162 is provided as an illustrative example, in other examples the low-power period 164 can be shorter or longer than the awake period 162 based on a cycle configuration.

The first cycle 158A begins with an awake period 162A, during which the modem 144 and the audio processor 106 transition from a low-power state to an active state. During the awake period 162, the modem 144 performs one or more uplink transmissions, one or more downlink transmissions, or a combination thereof, associated with the voice call. The audio processor 106 performs voice processing operations during a voice call processing period 172A, such as noise suppression (e.g., noise reduction and echo cancellation) and encoding operation of one or more portions of the voice call audio data 128. In an illustrative example, first and second portions of the voice call audio data 128 each represent 20 ms of voice content, and the first portion of the voice call audio data 128 includes microphone data that was buffered while the audio processor 106 was in the low-power state and retrieved upon the audio processor 106 transitioning to the active state. In an example, the second portion of the voice call audio data 128 includes microphone data that was at least partially buffered subsequent to the audio processor 106 transitioning to the active state. In another example, both the first portion and the second portion can be buffered while the audio processor 106 was in the low-power state. In yet another example, both the first portion and the second portion can be added to the buffer subsequent to the audio processor 106 transitioning to the active state. To illustrate, the audio processor 106 can retrieve portions of the voice call audio data 128 that are being written to the buffer in the active state, that have previously been written to the buffer in the low-power state, or a combination thereof. Although two encoding operations are described, it should be understood that fewer than two or more than two encoding operations may be performed during the voice call processing period 172A, one or more decoding operations for voice call data received via the modem 144 can be performed during the voice call processing period 172A, or any combination thereof.

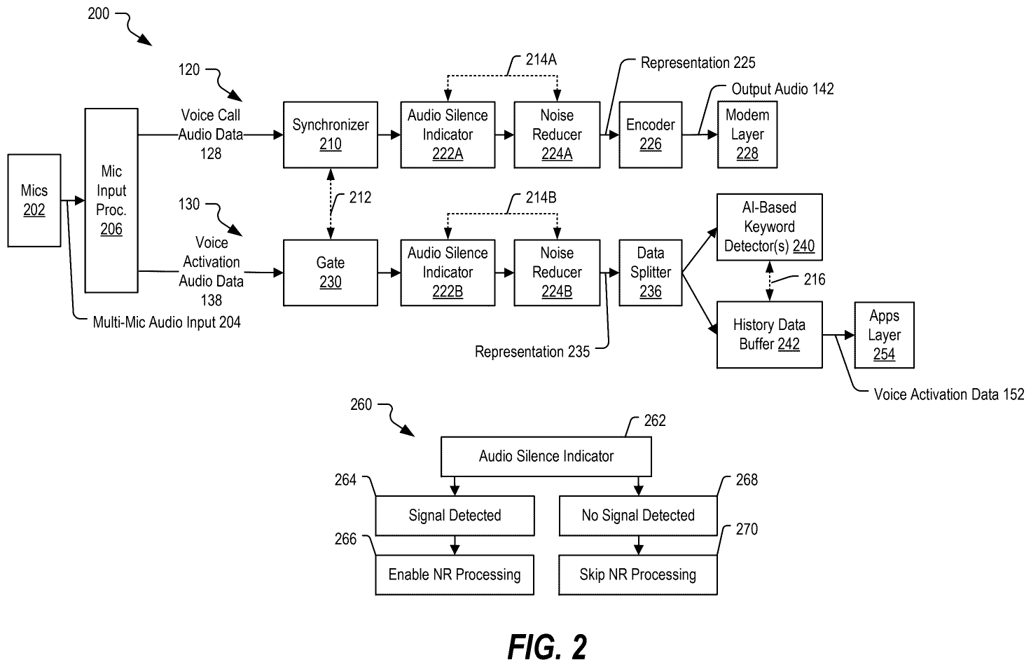

The audio processor 106 also processes portions of the voice activation audio data 138 during a voice activation processing period 182A of the awake period 162A. To illustrate, the audio processor 106 can load a first portion of the voice activation audio data 138 (e.g., buffered or partially buffered as described above with respect to the voice call audio data 128) in response to the audio processor 106 transitioning from the low-power state to the active state, as described in further detail with reference to FIG. 2.

The device 102 thus performs voice call data retrieval, selective noise suppression, and encoding to generate the output audio 142 at the audio processor 106, and also performs transmission of the output signal 146 via the modem 144, during the awake period 162A. The device 102 also performs voice activation data retrieval, selective noise suppression, and keyword detection to generate the voice activation data 152 (if any) during the awake period 162A. Upon completion of the awake period 162A, the modem 144 and the audio processor 106 halt operations and enter a low-power state during a low-power period 164A. To illustrate, the modem 144 ceases uplink and downlink activity and transitions to a sleep mode (or other low-power state) for the remainder of the first cycle 158A, and the audio processor 106 ceases processing of the voice call audio data 128 and the voice activation audio data 138 and transitions to a low-power state for the remainder of the first cycle 158A. In some embodiments, if the application processor 154 has no active threads, the application processor 154 can also transition to a low-power state during the low-power period 164A in conjunction with the low power island mode.

Upon completion of the low-power period 164A of the first cycle 158A, the second cycle 158B commences with an awake period 162B, during which the modem 144 and the audio processor 106 each transition from a low-power state to an active state. During the awake period 162B, the modem 144 resumes uplink and/or downlink activity associated with the voice call, and the audio processor 106 resumes processing of the voice call audio data 128 to generate a next set of output audio 142 for transmission to the device 148 via the modem 144 and also resumes processing of the voice activation audio data 138 to determine whether the generate the voice activation data 152.

To illustrate, the audio processor 106 performs voice call processing operations 170 during a voice call processing period 172B of the awake period 162B. The audio processor 106 also performs voice activation processing during a voice activation processing period 182B of the awake period 162B. To illustrate, the audio processor 106 can load a next portion of the voice activation audio data 138 from a buffer in response to the audio processor 106 transitioning from the low-power state to the active state.

Upon completion of the awake period 162B, the modem 144 and the audio processor 106 halt operations and enter a low-power state during a low-power period 164B. To illustrate, the modem 144 ceases uplink and downlink activity and transitions to a sleep mode (or other low-power state) for the remainder of the second cycle 158B, and the audio processor 106 ceases processing of the voice call audio data 128 and the voice activation audio data 138 and transitions to a low-power state for the remainder of the second cycle 158B.

In some embodiments, synchronization of the voice activation processing operations 180 with the modem operations 160 and the voice call processing operations 170 is performed using a voice timer to schedule voice processing threads at the audio processor 106 as well as to schedule audio processing threads for the voice activation audio data 138 according to timing criteria of the voice call. A central sleep manager can be configured to trigger entry into a low power island state in response to detecting that the voice processing threads and the audio processing threads are idle. In some embodiments, a synchronizer of the audio processor 106 is configured to signal a voice activation processing status to the central sleep manager, such as described further with reference to FIG. 2.

By aligning the voice call processing operations 170 associated with the voice call processing path 120 and the voice activation processing operations 180 associated with the voice activation processing path 130, the audio processor 106 can enter the low-power state during the low-power periods 164 associated with the sleep/wake cycle of the modem 144 and defined by the call timing criteria. As a result, power consumption of the audio processor 106 when providing voice activation functionality during a voice call is reduced as compared to conventional systems in which entry into the low-power state is prevented by voice activation processing periods that are not aligned with voice call processing periods.

It should be noted that the timing diagram 104 illustrates operation in which no keywords are detected in the voice activation audio data 138. For example, the voice activation processing period 182B ends within the awake period 162B, indicating that no keyword was detected in the portion of the voice activation audio data 138 that was processed during the voice activation processing period 182B. However, in an embodiment in which a keyword is detected in the portion of the voice activation audio data 138 that is processed during the voice activation processing period 182B, the voice activation processing period 182B continues past the awake period 162B and into the low-power period 164B while voice command recognition and related processing are performed. In such embodiments, the audio processor 106 may operate continuously through one or more subsequent low-power periods 164 without entering the low-power state until the voice activation processing has completed.

FIG. 2 is a diagram of particular aspects of the system of FIG. 1, in accordance with some examples of the present disclosure. In particular, FIG. 2 highlights an example of components 200 that can be implemented in the device 102, and a flow chart 260 of operations that can be performed by one or more of the components 200, according to a particular embodiment. Various data links are illustrated between some of the components 200 and are depicted using solid arrowed lines. According to an aspect, these data links correspond to robust unidirectional links between upstream and downstream components to seamlessly share and transfer data and metadata, ensuring efficient and reliable communication. In addition, various control links are illustrated between some of the components 200 and are depicted using dashed arrowed lines. According to an aspect, these control links correspond to bidirectional links exclusively for inter-module communication, facilitating the transfer of non-data elements, such as commands, control signals, and system-level instructions.

In the example illustrated in FIG. 2, the components 200 include one or more microphones, illustrated as multiple microphones 202 configured to provide a multi-microphone audio input 204 to a microphone input processing unit 206. According to an aspect, the microphone input processing unit 206 corresponds to a hardware abstraction layer that allows a computer's operating system (OS) to interact with hardware at a more general level and helps separate out the multi-microphone audio input 204 to different use case paths inputs, such as the voice call processing path 120 and the voice activation processing path 130. As illustrated, the microphone input processing unit 206 is configured to output the voice call audio data 128 and the voice activation audio data 138 based on the multi-microphone audio input 204. In an example, the microphone input processing unit 206 selects the voice call audio data 128 as the microphone feed from a designated user voice microphone, and generates the voice activation audio data 138 as an output of a beamforming operation of the multi-microphone audio input 204 directed toward a loudest speech source (e.g., other than the user's speech from the user voice microphone).

The voice call audio data 128 is provided to the voice call processing path 120, which includes a synchronizer 210, an audio silence indicator unit 222A, a noise reducer 224A, an encoder 226, and a modem layer 228. The synchronizer 210 is configured to send one or more control signals to a gate 230 of the voice activation processing path 130 to synchronize processing at the voice call processing path 120 and at the voice activation processing path 130. To illustrate, when processing commences at the voice call processing path 120 (e.g., in response to the transition from the low-power period 164A to the awake period 162B), the synchronizer 210 sends a control message via a control link 212 to open the gate 230, causing the voice activation processing path 130 to begin processing the voice activation audio data 138. In some embodiments the synchronizer 210 is also configured to receive process-done notifications, such as from the voice activation processing path 130 using a control link, and send a control message to close the gate 230.

The audio silence indicator unit 222A is configured to perform the first audio silence detection operation 122A of the voice call audio data 128 to compare the sound level of the voice call audio data 128 to the first threshold. Based on the comparison, the audio silence indicator unit 222A is configured to indicate, via a control link 214A, whether the noise reducer 224A is to perform the first noise suppression operation 124A on the voice call audio data 128 (e.g., based on the sound level being at or above the first threshold) or whether the first noise suppression operation 124A is to be bypassed (e.g., based on the sound level being below the first threshold, indicating silence).

The encoder 226 is configured to encode a representation 225 of the voice call audio data 128 that is received from the noise reducer 224A. For example, the representation 225 can correspond to a noise-suppressed version of the voice call audio data 128 after the first noise suppression operation 124A is performed, or can correspond to the voice call audio data 128 without noise suppression when the first noise suppression operation 124A is bypassed. In a particular embodiment, the encoder 226 is included in the codec 126 of FIG. 1.

The encoder 226 provides the resulting output audio 142 to the modem layer 228 for transmission as the output signal 146 to another device (e.g., the device 148). The modem layer 228 represents a layer that interacts with the modem-side processing at the modem 144, such as during voice calls over LTE/NR.

The voice activation processing path 130 includes the gate 230, an audio silence indicator unit 222B, a noise reducer 224B, a data splitter 236, one or more keyword detectors, such as one or more artificial intelligence (AI)-based keyword detectors 240, a history data buffer 242, and an application layer 254.

When the gate 230 is opened, such as responsive to a command received from the synchronizer 210 via the control link 212, the voice activation audio data 138 is provided to the audio silence indicator unit 222B. The audio silence indicator unit 222B is configured to perform the second audio silence detection operation 122B of the voice activation audio data 138 to compare the sound level of the voice activation audio data 138 to the second threshold. Based on the comparison, the audio silence indicator unit 222B is configured to indicate, via a control link 214B, whether the noise reducer 224B is to perform the second noise suppression operation 124B on the voice activation audio data 138 (e.g., based on the sound level being at or above the second threshold) or whether the second noise suppression operation 124B is to be bypassed (e.g., based on the sound level being below the second threshold, indicating silence), in a similar manner as previously described for the audio silence indicator unit 222A and the noise reducer 224A.

The noise reducer 224B is configured to output a representation 235 of the voice activation audio data 138. For example, the representation 235 can correspond to a noise-suppressed version of the voice activation audio data 138 when the second noise suppression operation 124B was performed, or can correspond to the voice activation audio data 138 without noise suppression when the second noise suppression operation 124B was bypassed.

The data splitter 236 is configured to provide the representation 235 of the voice activation audio data 138 to the history data buffer 242 and to the one or more AI-based keyword detectors 240 that are each configured to exchange commands with the history data buffer 242 via a control link 216. Each of the one or more AI-based keyword detectors 240 is configured to process the respective received copy of the representation 235 and to generate an indication of whether a keyword (e.g., “Hey Snapdragon”) associated with that AI-based keyword detector 240 is included in the voice activation audio data 138. Although described as AI-based, in other embodiments one or more of the keyword detectors 240 are not AI-based (e.g., do not operate using neural networks or other machine learning techniques). In response to a keyword being detected, the voice activation data 152 (e.g., an indication of the detected keyword and corresponding audio data from the history data buffer 242) is provided to the application layer 254. The application layer 254 represents a top layer where users can interact with the underlying hardware with the help of different voice activation applications, such as at the application processor 154.

The flow chart 260 illustrates an example of operations that can be performed to determine whether to perform noise reduction processing based on a sound level of an input signal. In an illustrative example, the operations depicted in the flow chart 260 are performed in the voice call processing path 120, in the voice activation processing path 130, or both. At block 262, an audio silence indicator is obtained. In an example, an audio silence indicator unit 222 generates the audio silence indicator based on a comparison of a sound level to a threshold. If a signal is detected, at block 264 (e.g., the sound level is equal to or greater than the threshold), then noise reduction processing is enabled, at block 266. In an example, the noise reduction processing corresponds to a noise suppression operation 124 performed at a noise reducer 224. Otherwise, if no signal is detected, at block 268 (e.g., the sound level is less than the threshold), then noise reduction processing is skipped (e.g., deactivated or bypassed), at block 270.

During operation according to a particular embodiment, in a given cycle, the synchronizer 210 sends control signals to the gate 230 to synchronize processing at the voice call processing path 120 and at the voice activation processing path 130. For example, in the first cycle 158A, the synchronizer 210 sends an open command to the gate 230 when voice call processing begins at the voice call processing path 120, allowing voice activation processing to commence at the voice activation processing path 130. Once this voice activation processing is done (e.g., after 12-14 ms of processing, in some examples), the voice activation processing path 130 communicates the process completion event to the synchronizer 210, such as a control signal sent to the synchronizer 210 via the control link 212 to indicate that processing at the voice activation processing path 130 is complete, and the gate 230 is closed. For example, the synchronizer 210 can send a close command to the gate 230 based on receiving the processing completion event. The synchronizer 210 and the gate 230 thus form components of a control mechanism that enables smooth synchronization between the voice call processing path 120 and the voice activation processing path 130.

According to an aspect, the synchronizer 210 also coordinates with a duty cycle manager (DCM) (not shown), which may correspond to a central sleep manager, to communicate voice activation active/idle durations to vote or de-vote for low power island mode. In an example, the DCM/central sleep manager is configured to trigger entry into a low power island state in response to detecting that processing threads for the voice call processing path 120 and for the voice activation processing path 130 are idle, and the synchronizer 210 is configured to signal a voice activation processing status to the DCM/central sleep manager. The DCM/central sleep manager tracks the active/idle duration of all the voice call and voice activation threads to trigger low power island entry via operation of power management resources once all of the threads transition to an idle state.

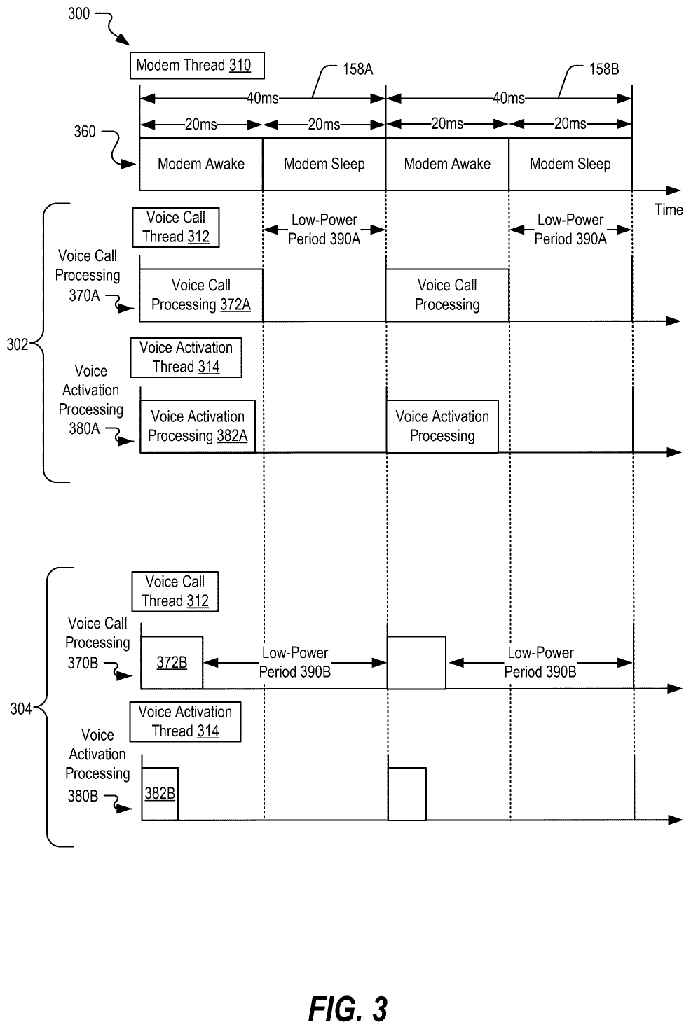

Incorporating the audio silence indicator units 222 in the voice call processing path 120 (for transmit, receive, or both) and in the voice activation processing path 130 can help indicate whether the audio environment includes a signal or silence, which can be used to optimize noise suppression processing by bypassing such processing during periods of silence. In addition, bypassing the noise suppression processing can enhance (e.g., lengthen) the low power island duration for a cycle 158, as described further with reference to FIG. 3. Such dynamic enablement/disablement for the noise reducers 224 depending on the environmental conditions, based on the audio silence indicator units 222, enables reduced overall voice call and voice activation processing. The reduced overall voice call and voice activation processing helps to prevent the audio processor 106 from being active during the modem sleep state, which helps in achieving a core logic (CX) power collapse during the entire modem sleep state without affecting the overall audio signal quality.

FIG. 3 depicts a timing diagram 300 of operations associated with processing voice call audio data and voice activation audio data for concurrent processing during a voice call. In a particular implementation, the operations are performed by the system 100, the device 102, or the audio processor 106 of FIG. 1, the components 200 of FIG. 2, or a combination thereof.

The timing diagram 300 depicts an example of operation in which transitions between an active state and a low-power state of the audio processor 106 are dynamically adjusted based on whether noise suppression is being performed at the voice call processing path 120 or the voice activation processing path 130. The timing diagram 300 depicts modem operations 360 of a modem thread 310, voice call processing operations 370 of a voice call thread 312, and voice activation processing operations 380 of a voice activation thread 314.

In a first scenario 302 in which noise suppression is performed in the voice call processing path 120 and the voice activation processing path 130, a set of voice call processing operations 370A are depicted having a duration that substantially matches the duration of the awake periods. For example, a voice call processing period 372A spans the entire duration of the awake period of the first cycle 158A, representing a sum of latencies associated with the synchronizer 210, the audio silence indicator unit 222A, the noise reducer 224A, and the encoder 226 of FIG. 2. A set of voice activation processing operations 380A are depicted having a duration that is slightly less than the duration of the awake periods. For example, a voice activation processing period 382A spans the most of the awake period of the first cycle 158A, representing a sum of latencies associated with the gate 230, the audio silence indicator unit 222B, the noise reducer 224B, the data splitter 236, and the AI-based keyword detector(s) 240 of FIG. 2. A low-power period 390A occurs when the modem thread 310, the voice call thread 312, and the voice activation thread 314 are idle and corresponds to a sleep period of the first cycle 158A.

For comparison, in a second scenario 304 in which noise suppression is bypassed in the voice call processing path 120 and the voice activation processing path 130, a set of voice call processing operations 370B are depicted having a duration that is approximately half of the duration of the awake periods. For example, a voice call processing period 372B has a duration that is substantially half of the duration of the awake period of the first cycle 158A, representing a sum of latencies associated with the synchronizer 210, the audio silence indicator unit 222A, and the encoder 226, but not the noise reducer 224A. A set of voice activation processing operations 380B are depicted having a duration that is less than the duration of the voice call processing operations 370B. For example, a voice activation processing period 382B spans approximately one-third of the awake period of the first cycle 158A, representing a sum of latencies associated with the gate 230, the audio silence indicator unit 222B, the data splitter 236, and the AI-based keyword detector(s) 240, but not the noise reducer 224B. A low-power period 390B begins when the voice call thread 312 and the voice activation thread 314 become idle, at which time the audio processor 106 may enter a low-power state, and the low-power period 390B continues into the sleep period of the first cycle 158A, at which point the modem thread 310 also becomes idle and a low power island associated with the modem 144 may be entered. According to some aspects, when silence is detected in both of the voice call processing path and the voice activation processing path, a power collapse associated with the low power island (e.g., power collapse associated with the audio processor 106) occurs prior to or concurrently with the modem sleep time.

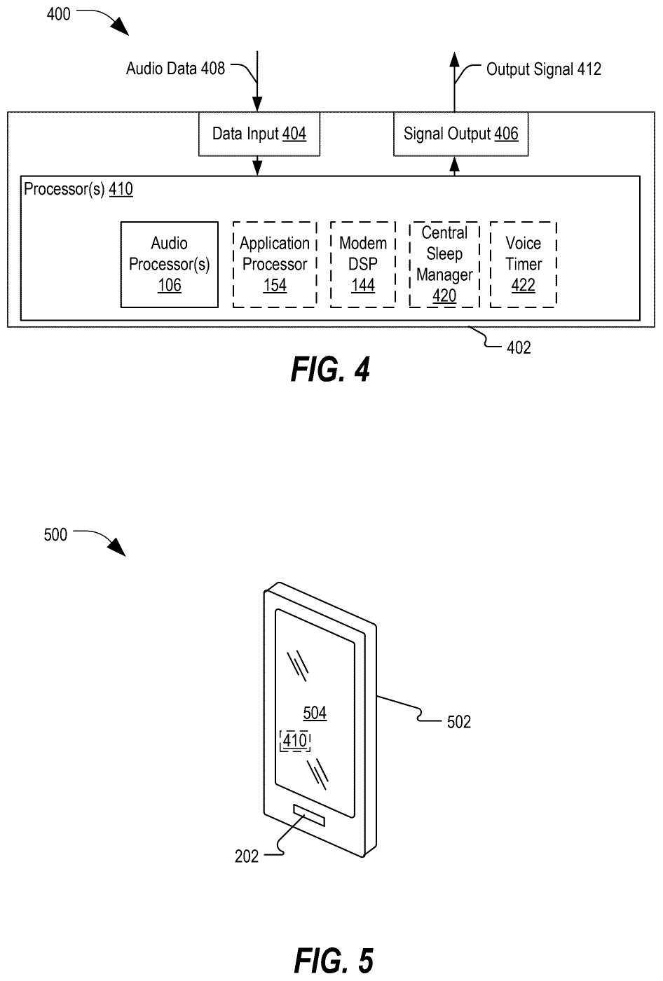

FIG. 4 depicts an implementation 400 of the device 102 as an integrated circuit 402 that includes one or more processors 410. The one or more processors 410 include the audio processor 106 and optionally include one or more of the application processor 154, the modem 144, a central sleep manager 420, and a voice timer 422.

According to an aspect, the voice timer 422 is configured to schedule voice call processing threads and voice activation processing threads according to timing criteria of a voice call, such as timing criteria based on a CDRx cycle configuration. For example, the voice timer 422 is configured to schedule the voice processing threads at the audio processor 106 (e.g., corresponding to the voice call processing path 120) based on timing criteria associated with the voice call so that none of the voice call processing threads associated with the voice call processing operations 170 are operative during the modem sleep periods. In addition to scheduling the voice call processing thread(s), the voice timer 422 may also schedule the voice activation processing threads at the audio processor 106 based on the timing criteria associated with the voice call so that none of the voice activation processing threads associated with the voice activation processing operations 180 are operative during the modem sleep periods. To illustrate, the voice timer 422 can correspond to a software thread of the audio processor 106 that assigns resources, such as clocks and memory bandwidth, to the various subscribed threads so that resources are allocated to the voice call processing threads and the voice activation processing threads during the modem awake periods and deallocated from the voice call processing threads and the voice activation processing threads (when no keyword is detected) during the modem sleep periods.

According to an aspect, the central sleep manager 420 is configured to track processing threads at the audio processor 106 and control transitions of the audio processor 106 between an active state and a low power island state. In a particular example, the central sleep manager 420 corresponds to a duty cycle manager and is configured to trigger entry into a low power island state in response to detecting that the voice call processing threads and the voice activation processing threads are idle. Similarly, if not in use servicing other applications, the application processor 154 can also be transitioned to a low power state during the low-power periods.

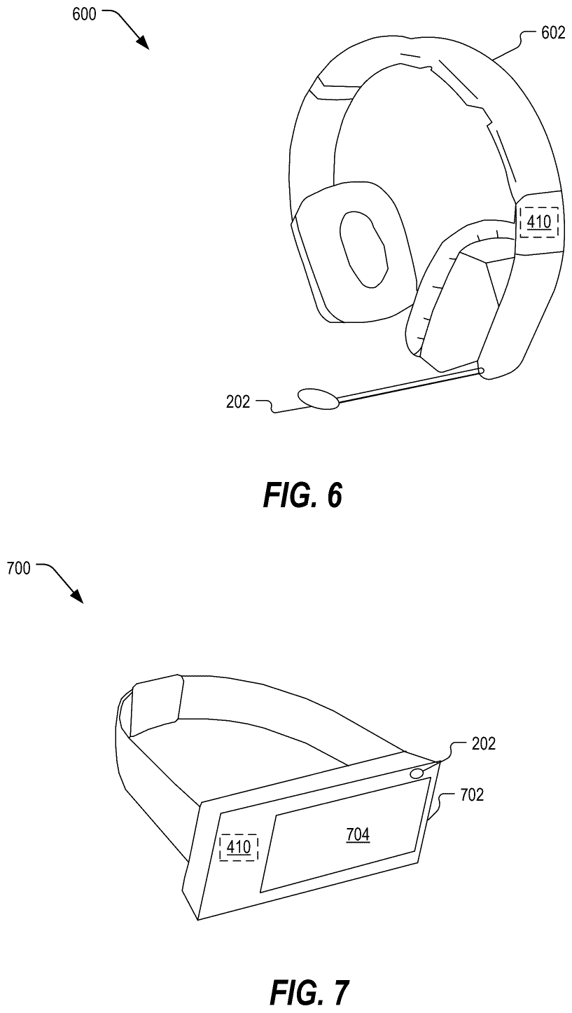

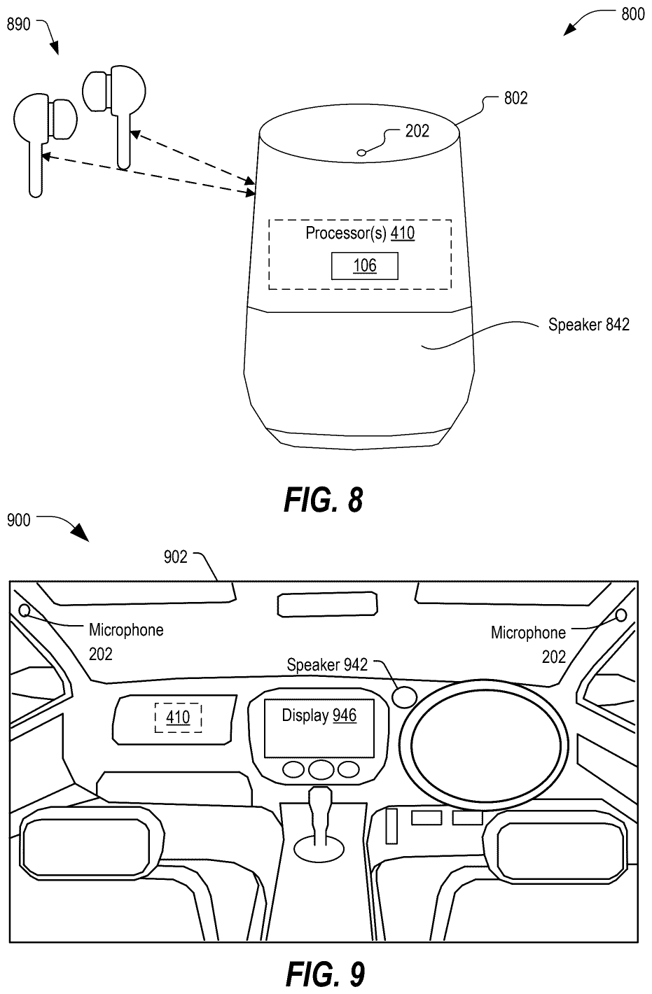

The integrated circuit 402 also includes a data input 404, such as one or more microphone inputs and/or bus interfaces, to enable audio data 408 to be received for processing. To illustrate, the audio data 408 can correspond to the voice call audio data 128, the voice activation audio data 138, or both, as illustrative, non-limiting examples. The integrated circuit 402 also includes a signal output 406, such as a bus interface, to enable sending of an output signal 412, such as the output audio 142, the output signal 146, or the voice activation data 152, as illustrative, non-limiting examples. The integrated circuit 402 enables the audio processor 106 to be integrated (e.g., included as a component) in a system that may include microphones, such as a mobile phone or tablet computer device as depicted in FIG. 5, a headset device that includes a microphone configured to provide the voice call audio data 128, as depicted in FIG. 6, a wearable electronic device as depicted in FIG. 7, a voice-controlled speaker system as depicted in FIG. 8, or a vehicle as depicted in FIG. 9.

FIG. 5 depicts an implementation 500 in which the device 102 includes a mobile device 502, such as a phone or tablet computer device, as illustrative, non-limiting examples. The mobile device 502 includes at least one microphone 202 and a display screen 504. The one or more processors 410 including the audio processor 106 are integrated in the mobile device 502 and are illustrated using dashed lines to indicate internal components that are not generally visible to a user of the mobile device 502. In a particular example, the audio processor 106 is configured to, responsive to user instructions (e.g., received via a voice activation command), initiate voice activation functionality during a voice call and to align the active periods of voice call audio and voice activation audio processing to enable low-power operation (e.g., to support a low power island state) during the voice call.

FIG. 6 depicts an implementation 600 in which the device 102 includes a headset device 602. The headset device 602 includes at least one microphone 202, and the one or more processors 410 including the audio processor 106 are integrated in the headset device 602. In a particular example, the audio processor 106 is configured to, responsive to user instructions (e.g., received via a voice activation command), initiate voice activation functionality during a voice call and to align the active periods of voice call audio and voice activation audio processing to enable low-power operation (e.g., to support a low power island state) during the voice call. Although illustrated as an audio headset, in other implementations the headset device 602 can correspond to an extended reality headset, such as a virtual reality, mixed reality, or augmented reality headset.

FIG. 7 depicts an implementation 700 in which the device 102 includes a wearable electronic device 702, illustrated as a “smart watch.” At least one microphone 202 and the one or more processors 410 including the audio processor 106 are integrated into the wearable electronic device 702. In a particular example, the audio processor 106 is configured to, responsive to user instructions (e.g., received via a voice activation command), initiate voice activation functionality during a voice call and to align the active periods of voice call audio and voice activation audio processing to enable low-power operation (e.g., to support a low power island state) during the voice call. In a particular example, the wearable electronic device 702 includes a haptic device that provides a haptic notification (e.g., vibrates) in response to detection of an incoming call during which voice activation functionality may be concurrently provided.

FIG. 8 is an implementation 800 in which the device 102 includes a wireless speaker and voice activated device 802. The wireless speaker and voice activated device 802 can have wireless network connectivity and is configured to execute an assistant operation. At least one microphone 202 and the one or more processors 410 including the audio processor 106 are included in the wireless speaker and voice activated device 802. The wireless speaker and voice activated device 802 also includes a speaker 842 and supports use of a wireless headset, illustrated as a pair of in-ear earphones 890, which can optionally be used by a user for music playback and/or participating in voice calls via the wireless speaker and voice activated device 802. During operation, in response to receiving a verbal command identified as user speech via the microphone 202 or via wireless signaling from the earphones 890, the wireless speaker and voice activated device 802 can initiate voice activation functionality during a voice call, and align the active periods of voice call audio and voice activation audio processing to enable low-power operation (e.g., to support a low power island state) during the voice call. The voice activation functionality can include executing assistant operations, such as via execution of a voice activation system (e.g., an integrated assistant application). The assistant operations can be performed during an ongoing voice call.

FIG. 9 depicts an implementation 900 in which the device 102 corresponds to, or is integrated within, a vehicle 902, illustrated as a car. The vehicle 902 includes the one or more processors 410 including the audio processor 106. The vehicle 902 also includes microphones 202 positioned to capture utterances of an operator and/or one or more users of the vehicle 902. User voice activity detection can be performed based on audio signals received from the microphones 202, including one or more user commands during an ongoing voice call (e.g., received via a voice activation command), to initiate voice activation functionality during a voice call, and the active periods of voice call audio and voice activation audio processing may be aligned to enable low-power operation (e.g., to support a low power island state) during the voice call. For example, while a voice call is ongoing for a user of the vehicle 902 (via one or more of the microphones 202 and a speaker 942), the user or another occupant of the vehicle 902 may engage in voice activation commands via the microphones 202, such as to display a navigation interface at a display 946.

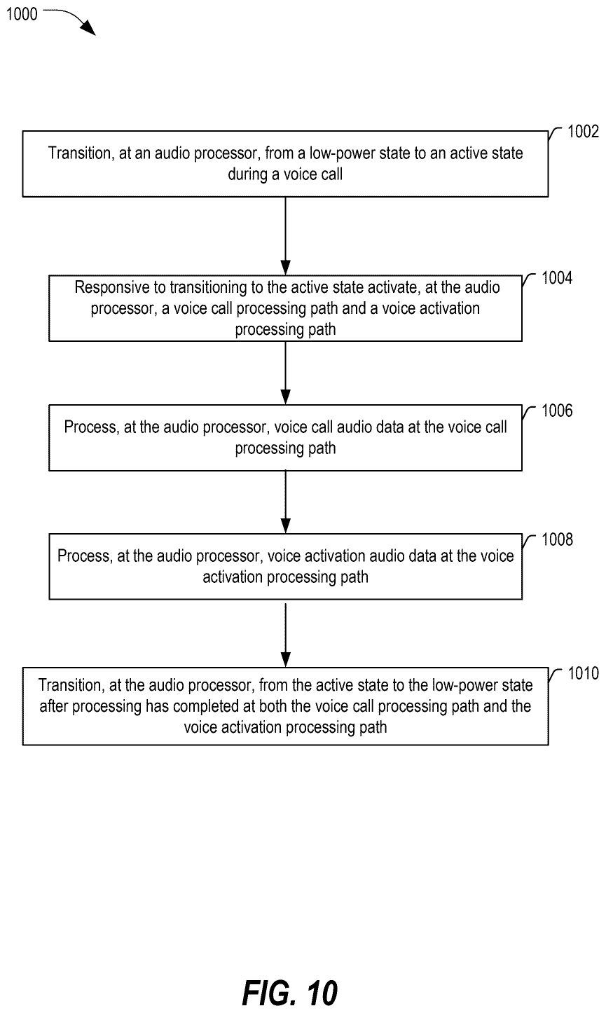

Referring to FIG. 10, a particular implementation of a method 1000 of performing concurrent voice call and voice activation processing is shown. In a particular aspect, one or more operations of the method 1000 are performed by at least one of the audio processor 106, the modem 144, the application processor 154, or the device 102 of FIG. 1, one or more of the components 200 of FIG. 2, the central sleep manager 420, or the voice timer 422 of FIG. 4, or a combination thereof.

The method 1000 includes, at block 1002, transitioning, at an audio processor, from a low-power state to an active state during a voice call. For example, the audio processor 106 transitions from the low-power state to the active state upon entering the awake period 162A of the first cycle 158A associated with the voice call.

The method 1000 includes, responsive to transitioning to the active state, activating a voice call processing path and a voice activation processing path, at block 1004; processing voice call audio data at the voice call processing path, at block 1006; and processing voice activation audio data at the voice activation processing path, at block 1008. For example, upon entering the awake period 162A, the audio processor 106 activates the voice call processing path 120 and the voice activation processing path 130, initiates processing of the voice call audio data 128 at the voice call processing path 120, and initiates processing of the voice activation audio data 138 at the voice activation processing path 130.

The method 1000 also includes, at block 1010, transitioning, at the audio processor, from the active state to the low-power state after processing has completed at both the voice call processing path and the voice activation processing path. To illustrate, the audio processor 106 generates the output audio 142 and the voice activation data 152 during the awake period 162A of the first cycle 158A associated with the voice call, and transitions from the active state to the low-power state upon exiting the awake period 162A and entering the low-power period 164A of the first cycle 158A associated with the voice call.

In some implementations, the method 1000 also includes performing a first silence detection operation in the voice call processing path and a second silence detection operation in the voice activation processing path. For example, the audio processor 106 performs the first audio silence detection operation 122A in the voice call processing path 120 and performs the second audio silence detection operation 122B in the voice activation processing path 130. The method 1000 can also include selectively bypassing at least one of a first noise suppression operation in the voice call processing path based on the first silence detection operation or a second noise suppression operation in the voice activation processing path based on the second silence detection operation. For example, at least one of the first noise suppression operation 124A of the voice call processing path 120 or the second noise suppression operation 124B of the voice activation processing path 130 can be bypassed in response to the corresponding first audio silence detection operation 122A or second audio silence detection operation 122B detecting silence (e.g., a sound level lower than a threshold).

By aligning voice call data processing operations and voice activation data processing operations to occur during the active state, the method 1000 enables the audio processor to enter the low-power state during low-power periods associated with the sleep/wake timing criteria associated with the voice call. As a result, power consumption of the audio processor when supporting voice activation functionality is reduced as compared to conventional systems in which entry into the low-power state is prevented by keyword detection operations that may be continuous or that are not aligned with the voice call processing operations.

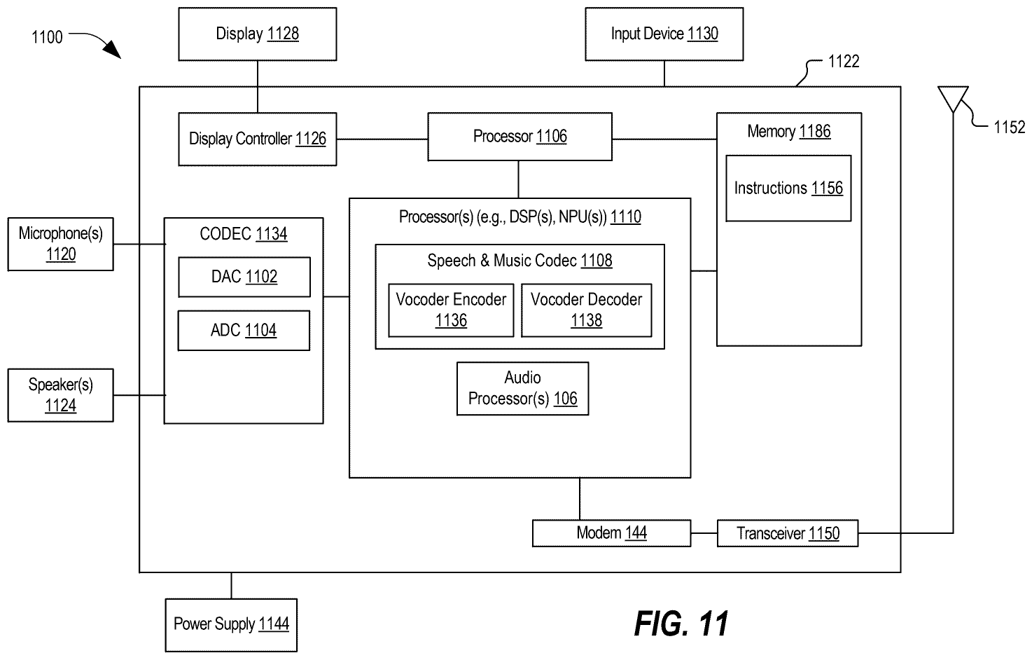

The method 1000 of FIG. 10 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1000 of FIG. 10 may be performed by a processor that executes instructions, such as described with reference to FIG. 11.

Referring to FIG. 11, a block diagram of a particular illustrative implementation of a device is depicted and generally designated 1100. In various implementations, the device 1100 may have more or fewer components than illustrated in FIG. 11. In an illustrative implementation, the device 1100 may correspond to the device 102. In an illustrative implementation, the device 1100 may perform one or more operations described with reference to FIGS. 1-10.

In a particular implementation, the device 1100 includes a processor 1106 (e.g., a CPU). The device 1100 may include one or more additional processors 1110 (e.g., one or more DSPs, one or more neural processing units (NPUs), or a combination thereof). In a particular aspect, the audio processor 106 of FIG. 1 is included in or corresponds to the processors 1110, the application processor 154 is included in or corresponds to the processor 1106, or a combination thereof. The processors 1110 may include a speech and music coder-decoder (CODEC) 1108 that includes a voice coder (“vocoder”) encoder 1136, a vocoder decoder 1138, or a combination thereof. In some implementations, the speech and music codec 1108 corresponds to, or is included in, the codec 126.

The device 1100 may include a memory 1186 and a CODEC 1134. The memory 1186 may include instructions 1156 that are executable by the one or more additional processors 1110 (or the processor 1106) to implement the functionality described with reference to the audio processor 106, the central sleep manager 420, the voice timer 422, the application processor 154, or any combination thereof. The device 1100 may include the modem 144 coupled, via a transceiver 1150, to an antenna 1152.

The device 1100 may include a display 1128 coupled to a display controller 1126. One or more speakers 1124 and one or more microphones 1120 may be coupled to the CODEC 1134. In a particular aspect, the one or more microphones 1120 include the microphones 202. The CODEC 1134 may include a digital-to-analog converter (DAC) 1102, an analog-to-digital converter (ADC) 1104, or both. In a particular implementation, the CODEC 1134 may receive analog signals from the microphone 1120, convert the analog signals to digital signals using the analog-to-digital converter 1104, and provide the digital signals to the speech and music codec 1108. In a particular implementation, the speech and music codec 1108 may provide digital signals to the CODEC 1134. The CODEC 1134 may convert the digital signals to analog signals using the digital-to-analog converter 1102 and may provide the analog signals to the speaker 1124.

In a particular implementation, the device 1100 may be included in a system-in-package or system-on-chip device 1122. In a particular implementation, the memory 1186, the processor 1106, the processors 1110, the display controller 1126, the CODEC 1134, the transceiver 1150, and the modem 144 are included in the system-in-package or system-on-chip device 1122. In a particular implementation, an input device 1130 and a power supply 1144 are coupled to the system-in-package or the system-on-chip device 1122. Moreover, in a particular implementation, as illustrated in FIG. 11, the display 1128, the input device 1130, the speaker 1124, the microphone 1120, the antenna 1152, and the power supply 1144 are external to the system-in-package or the system-on-chip device 1122. In a particular implementation, each of the display 1128, the input device 1130, the speaker 1124, the microphone 1120, the antenna 1152, and the power supply 1144 may be coupled to a component of the system-in-package or the system-on-chip device 1122, such as an interface or a controller.

The device 1100 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, an extended reality (XR) device, a base station, a mobile device, or any combination thereof.

In conjunction with the described implementations, an apparatus includes means for transitioning from a low-power state to an active state during a voice call. For example, the means for transitioning from a low-power state to an active state can correspond to the audio processor 106, the device 102, the synchronizer 210, the gate 230, the central sleep manager 420, the voice timer 422, the processor 1106, the one or more processors 1110, one or more other circuits or components configured to transition from a low-power state to an active state during a voice call, or any combination thereof.

The apparatus includes means for activating a voice call processing path and a voice activation processing path responsive to transitioning to the active state. For example, the means for activating can correspond to the audio processor 106, the device 102, the voice call processing path 120, the voice activation processing path 130, the synchronizer 210, the central sleep manager 420, the voice timer 422, the processor 1106, the one or more processors 1110, one or more other circuits or components configured to activate a voice call processing path and a voice activation processing path responsive to transitioning to the active state, or any combination thereof.

The apparatus includes means for means for processing voice call audio data at the voice call processing path. For example, the means for processing voice call audio data at the voice call processing path can correspond to the audio processor 106, the device 102, the voice call processing path 120, the synchronizer 210, the audio silence indicator unit 222A, the noise reducer 224A, the encoder 226, the processor 1106, the one or more processors 1110, one or more other circuits or components configured to process voice call audio data at the voice call processing path, or any combination thereof.

The apparatus also includes means for processing voice activation audio data at the voice activation processing path. For example, the means for means for processing voice activation audio data at the voice activation processing path can correspond to the audio processor 106, the device 102, the voice activation processing path 130, the synchronizer 210, the gate 230, the audio silence indicator unit 222B, the noise reducer 224B, the data splitter 236, the AI-based keyword detector 240, the history data buffer 242, the processor 1106, the one or more processors 1110, one or more other circuits or components configured to process voice activation audio data at the voice activation processing path, or any combination thereof.

The apparatus also includes means for transitioning from the active state to the low-power state after processing has completed at both the voice call processing path and the voice activation processing path. For example, the means for transitioning from the active state to the low-power state after processing has completed at both the voice call processing path and the voice activation processing path can correspond to the audio processor 106, the device 102, the voice call processing path 120, the voice activation processing path 130, the synchronizer 210, the gate 230, the central sleep manager 420, the voice timer 422, the processor 1106, the one or more processors 1110, one or more other circuits or components configured to transition from the active state to the low-power state after processing has completed at both the voice call processing path and the voice activation processing path, or any combination thereof.

In some implementations, a non-transitory computer-readable medium (e.g., a computer-readable storage device, such as the memory 1186) includes instructions (e.g., the instructions 1156) that, when executed by one or more processors (e.g., the audio processor 106, the one or more processors 1110, or the processor 1106), cause the one or more processors to transition from a low-power state to an active state during a voice call and, responsive to transitioning to the active state: activate a voice call processing path (e.g., the voice call processing path 120) and a voice activation processing path (e.g., the voice activation processing path 130); process voice call audio data (e.g., the voice call audio data 128) at the voice call processing path; and process voice activation audio data (e.g., the voice activation audio data 138) at the voice activation processing path; and after processing has completed at both the voice call processing path and the voice activation processing path, transition from the active state to the low-power state.

Particular aspects of the disclosure are described below in sets of interrelated Examples:

According to Example 1, a device includes an audio processor configured to responsive to transitioning from a low-power state to an active state during a voice call: activate a voice call processing path and a voice activation processing path; process, at the voice call processing path, voice call audio data; and process, at the voice activation processing path, voice activation audio data; and after processing has completed at both the voice call processing path and the voice activation processing path, transition from the active state to the low-power state.

Example 2 includes the device of Example 1, wherein the audio processor is configured to perform a silence detection operation in each of the voice call processing path and the voice activation processing path and to selectively bypass a noise suppression operation in at least one of the voice call processing path or the voice activation processing path based on the silence detection operation.

Example 3 includes the device of Example 1 or Example 2, wherein the audio processor is configured to perform a first silence detection operation of the voice call audio data; and selectively perform, at the voice call processing path, a first noise suppression operation based on the first audio silence detection operation.

Example 4 includes the device of any of Examples 1 to 3, wherein the audio processor is configured to perform a second silence detection operation of the voice activation audio data; and selectively perform, at the voice activation processing path, a second noise suppression operation based on the second audio silence detection operation.

Example 5 includes the device of any of Examples 1 to 4, wherein the voice call processing path includes: a first audio silence detector configured to perform a first silence detection operation on the voice call audio data; a first noise suppressor configured to selectively perform a first noise suppression operation of the voice call audio data based on the first audio silence detector; and an encoder configured to encode an output of the first noise suppressor; and wherein the voice activation processing path includes: a second audio silence detector configured to perform a second silence detection operation on the voice activation audio data; a second noise suppressor configured to selectively perform a second noise suppression operation of the voice activation audio data based on the second audio silence detector; and a keyword detector configured to process an output of the second noise suppressor.

Example 6 includes the device of any of Examples 1 to 5, wherein the voice call processing path includes a synchronizer and the voice activation processing path includes a gate, and wherein the synchronizer is configured to send one or more control signals to the gate to synchronize processing at the voice call processing path and at the voice activation processing path.

Example 7 includes the device of Example 6, wherein the voice activation processing path is configured to send the one or more control signal to the synchronizer to indicate that processing at the voice activation processing path is complete.

Example 8 includes the device of Example 6 or Example 7, wherein a central sleep manager is configured to trigger entry into a low power island state in response to detecting that processing threads for the voice call processing path and for the voice activation processing path are idle, and wherein the synchronizer is configured to signal a voice activation processing status to the central sleep manager.

Example 9 includes the device of any of Examples 1 to 8 and further includes a modem configured to initiate transmission of an output signal based on the voice call audio data.

Example 10 includes the device of Example 9, wherein the transitions between the active state and the low-power state of the modem are aligned with transitions of the audio processor between the active state and the low-power state to enable synchronized processing using a low power island.

Example 11 includes the device of Example 10 wherein, when silence is detected in both of the voice call processing path and the voice activation processing path, a power collapse associated with the low power island occurs prior to or concurrently with a modem sleep time.

Example 12 includes the device of Example 10 or Example 11, wherein the voice call is a connected mode discontinuous reception (CDRx) call, and wherein the modem sleep time is based on a CDRx cycle configuration.

Example 13 includes the device of any of Examples 1 to 12 and further includes an application processor configured to process an output of the voice activation processing path.

Example 14 includes the device of any of Examples 1 to 13 and further includes one or more microphones configured to provide input audio data corresponding to the voice call audio data and the voice activation audio data.

Example 15 includes the device of Example 14, wherein the audio processor is integrated in a headset device that includes the one or more microphones.

Example 16 includes the device of any of Examples 1 to 14, wherein the audio processor is integrated in at least one of a mobile phone, a tablet computer device, or a wearable electronic device.

According to Example 17, a method includes transitioning, at an audio processor, from a low-power state to an active state during a voice call and, responsive to transitioning to the active state: activating a voice call processing path and a voice activation processing path; processing voice call audio data at the voice call processing path; and processing voice activation audio data at the voice activation processing path; and transitioning, at the audio processor, from the active state to the low-power state after processing has completed at both the voice call processing path and the voice activation processing path.

Example 18 includes the method of Example 17, and further includes performing a first silence detection operation in the voice call processing path and a second silence detection operation in the voice activation processing path; and selectively bypassing at least one of a first noise suppression operation in the voice call processing path based on the first silence detection operation or a second noise suppression operation in the voice activation processing path based on the second silence detection operation.

According to Example 19, a device includes: a memory configured to store instructions; and a processor configured to execute the instructions to perform the method of Example 17 or Example 18.

According to Example 20, a non-transitory computer-readable medium stores instructions that, when executed by a processor, cause the processor to perform the method of Example 17 or Example 18.

According to Example 21, an apparatus includes means for carrying out the method of Example 17 or Example 18.

According to Example 22, a non-transitory computer readable medium storing instructions that, when executed by an audio processor, cause the audio processor to: transition from a low-power state to an active state during a voice call and, responsive to transitioning to the active state: activate a voice call processing path and a voice activation processing path; process voice call audio data at the voice call processing path; and process voice activation audio data at the voice activation processing path; and after processing has completed at both the voice call processing path and the voice activation processing path, transition from the active state to the low-power state.

Example 23 includes the non-transitory computer readable medium of Example 19 wherein the instructions, when executed by the audio processor, further cause the audio processor to: perform a first silence detection operation in the voice call processing path and a second silence detection operation in the voice activation processing path; and selectively bypass at least one of a first noise suppression operation in the voice call processing path based on the first silence detection operation or a second noise suppression operation in the voice activation processing path based on the second silence detection operation.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
an audio processor configured to:
responsive to transitioning from a low-power state to an active state during a voice call:
activate a voice call processing path and a voice activation processing path;
process, at the voice call processing path, voice call audio data; and
process, at the voice activation processing path, voice activation audio data; and
after processing has completed at both the voice call processing path and the voice activation processing path, transition from the active state to the low-power state.

2. The device of claim 1, wherein the audio processor is configured to perform a silence detection operation in each of the voice call processing path and the voice activation processing path and to selectively bypass a noise suppression operation in at least one of the voice call processing path or the voice activation processing path based on the silence detection operation.

3. The device of claim 1, wherein the audio processor is configured to:
perform a first silence detection operation of the voice call audio data; and
selectively perform, at the voice call processing path, a first noise suppression operation based on the first silence detection operation.

4. The device of claim 1, wherein the audio processor is configured to:
perform a second silence detection operation of the voice activation audio data; and
selectively perform, at the voice activation processing path, a second noise suppression operation based on the second silence detection operation.

5. The device of claim 1, wherein the voice call processing path includes:
a first audio silence detector configured to perform a first silence detection operation on the voice call audio data;
a first noise suppressor configured to selectively perform a first noise suppression operation of the voice call audio data based on the first audio silence detector; and
an encoder configured to encode an output of the first noise suppressor; and
wherein the voice activation processing path includes:
a second audio silence detector configured to perform a second silence detection operation on the voice activation audio data;
a second noise suppressor configured to selectively perform a second noise suppression operation of the voice activation audio data based on the second audio silence detector; and
a keyword detector configured to process an output of the second noise suppressor.

6. The device of claim 1, wherein the voice call processing path includes a synchronizer and the voice activation processing path includes a gate, and wherein the synchronizer is configured to send one or more control signals to the gate to synchronize processing at the voice call processing path and at the voice activation processing path.

7. The device of claim 6, wherein the voice activation processing path is configured to send the one or more control signal to the synchronizer to indicate that processing at the voice activation processing path is complete.

8. The device of claim 7, wherein a central sleep manager is configured to trigger entry into a low power island state in response to detecting that processing threads for the voice call processing path and for the voice activation processing path are idle, and wherein the synchronizer is configured to signal a voice activation processing status to the central sleep manager.

9. The device of claim 1, further comprising a modem configured to initiate transmission of an output signal based on the voice call audio data.

10. The device of claim 9, wherein the transitions between the active state and the low-power state of the modem are aligned with transitions of the audio processor between the active state and the low-power state to enable synchronized processing using a low power island.

11. The device of claim 10 wherein, when silence is detected in both of the voice call processing path and the voice activation processing path, a power collapse associated with the low power island occurs prior to or concurrently with a modem sleep time.

12. The device of claim 10, wherein the voice call is a connected mode discontinuous reception (CDRx) call, and wherein the modem sleep time is based on a CDRx cycle configuration.

13. The device of claim 1, further comprising an application processor configured to process an output of the voice activation processing path.

14. The device of claim 1, further comprising one or more microphones configured to provide input audio data corresponding to the voice call audio data and the voice activation audio data.

15. The device of claim 14, wherein the audio processor is integrated in a headset device that includes the one or more microphones.

16. The device of claim 1, wherein the audio processor is integrated in at least one of a mobile phone, a tablet computer device, or a wearable electronic device.

17. A method comprising:
transitioning, at an audio processor, from a low-power state to an active state during a voice call and, responsive to transitioning to the active state:
activating a voice call processing path and a voice activation processing path;
processing voice call audio data at the voice call processing path; and
processing voice activation audio data at the voice activation processing path; and
transitioning, at the audio processor, from the active state to the low-power state after processing has completed at both the voice call processing path and the voice activation processing path.

18. The method of claim 17, further comprising:
performing a first silence detection operation in the voice call processing path and a second silence detection operation in the voice activation processing path; and
selectively bypassing at least one of a first noise suppression operation in the voice call processing path based on the first silence detection operation or a second noise suppression operation in the voice activation processing path based on the second silence detection operation.

19. A non-transitory computer readable medium storing instructions that, when executed by an audio processor, cause the audio processor to:
transition from a low-power state to an active state during a voice call and, responsive to transitioning to the active state:
activate a voice call processing path and a voice activation processing path;
process voice call audio data at the voice call processing path; and
process voice activation audio data at the voice activation processing path; and
after processing has completed at both the voice call processing path and the voice activation processing path, transition from the active state to the low-power state.

20. The non-transitory computer readable medium of claim 19 wherein the instructions, when executed by the audio processor, further cause the audio processor to:
perform a first silence detection operation in the voice call processing path and a second silence detection operation in the voice activation processing path; and
selectively bypass at least one of a first noise suppression operation in the voice call processing path based on the first silence detection operation or a second noise suppression operation in the voice activation processing path based on the second silence detection operation.
